(19) United States
(12) Patent Application Publication
(10) Pub. No.: US 2021/0220876 A1
(43) Pub. Date: Jul. 22, 2021

(54) APPARATUS FOR FEEDING AN UNSTACKER MAGAZINE WITH MAILPIECES ON EDGE

(71) Applicant: SOLYSTIC, Bagneux (FR)

(72) Inventors: Damien Hugues, Upie (FR); Christian Duclot, Annonay (FR)

(21) Appl. No.: 16/302,993

(22) PCT Filed: Oct. 17, 2018
(86) PCT No.: PCT/FR2018/052581

§ 371 Date: Nov. 19, 2018

(30) Foreign Application Priority Data
Dec. 29, 2017 (FR) 1763370

(51) Int. Cl. B07C 1/02; B65G 47/38; B65H 1/02; B65H 1/30

(52) U.S. Cl. CPC B07C 1/02; B65G 47/38; B65H 2701/1916; B65H 1/30; B65H 1/025

(57) ABSTRACT

The invention relates to apparatus (1) for feeding an unstacker magazine (2) with mailpieces (3) on edge. The apparatus comprises a conveyor bed (4) designed to convey the mailpieces on edge to the unstacker magazine in a first conveying direction, a feed conveyor (5) designed to convey trays (6) loaded with mailpieces to the conveyor bed in a second conveying direction (F2) and tray tipper means (7) interposed between the feed conveyor and the conveyor bed, which means are designed to tip a tray (6) over onto one side from the feed conveyor onto the conveyor bed in such a manner as to bring the mailpieces on edge from the tray to the unstacker magazine.

### TECHNICAL FIELD

The invention relates to the field of processing mailpieces at a postal sorting or logistics center.

The invention relates more particularly to apparatus for feeding an unstacker magazine with mailpieces.

### PRIOR ART

Document FR 2 663 915 discloses apparatus specifically designed to feed an unstacker magazine with mailpieces on edge from mailpieces that are sequenced and stacked flat in trays, and that are generally large-format mailpieces.

That apparatus comprises a feed conveyor that transports the trays to the unstacker magazine in a certain conveying direction while said trays are in sequence and extend crosswise, with an automated tray tipper system provided at a downstream end of the conveyor to tip the trays one-by-one forwards in the conveying direction onto the unstacker magazine.

The stack of mailpieces stored flat in the tray is thus tipped forwards so that the mailpieces find themselves on edge in the tray, and slide onto the unstacker magazine so as then to be moved to the unstacker by an operative by means of a paddle.

However, that feed apparatus is not adapted for processing mailpieces that are stored on edge in trays.

Trays loaded with mailpieces on edge generally extend lengthwise on the conveyor, thereby preventing them from being tipped by tray tipper means for tipping trays that extend crosswise.

In addition, even if a tray extending lengthwise were tipped via the front, the mailpieces on edge would either be laid flat on the unstacker magazine or would still be on edge but without being sequenced.

That is why the mailpieces stored on edge in the trays are generally processed manually by operatives who, themselves, handle the operation of tipping and of angularly positioning the tray on the unstacking magazine.

Since trays loaded with mailpieces are heavy and voluminous, that tray-handling operation is tiring for operatives.

Document DE-A-10 2006 031 119 also describes apparatus for feeding an unstacker magazine with a tray tipper system that also fails to solve the above-mentioned problem.

### SUMMARY OF THE INVENTION

An object of the invention is thus to solve the above-mentioned problems.

To this end the invention provides apparatus for feeding an unstacker magazine with mailpieces on edge, said apparatus comprising a conveyor bed designed to convey the mailpieces on edge to the unstacker magazine in a first conveying direction, a feed conveyor designed to convey trays loaded with mailpieces to the conveyor bed in a second conveying direction and tray tipper means interposed between said feed conveyor and said conveyor bed, which means are designed to tip a tray over onto one side from the feed conveyor onto the conveyor bed in such a manner as to bring the mailpieces on edge from the tray to the unstacker magazine, said apparatus being characterized in that said tray tipper means form an L-shaped cradle designed to receive a tray in such a manner that it is inclined transversely to said first and second conveying directions between the feed conveyor and the conveyor bed, and in that said tray tipper means further comprise a tray-receiving plate that overlies the conveyor bed in front of the L-shaped cradle and in which a tray-receiving indent is formed, said indent being arranged to block a tray when it is tipped from the L-shaped cradle onto the plate in order to enable the mailpieces to be unloaded on edge onto the tray-receiving plate.

The basic idea of the invention consists in tipping the trays sideways to direct the mailpieces on edge and in sequence onto the conveyor bed while also limiting the effort of the operative.

With the apparatus of the invention, the operative is thus positioned facing the tray-receiving plate so as to slide the tray into the L-shaped cradle, so as to tip it onto the tray-receiving plate, so as to retrieve the stack of mailpieces on edge removed from the tray, and so as to move said stack by sliding it onto the conveyor bed.

The tray-receiving indent in the tray-receiving plate makes it possible to block the tray in order to facilitate unloading the mailpieces onto the tray-receiving plate.

The tray tipper means thus make it possible to process mailpieces that are oriented both in landscape mode and in portrait mode in the trays, also known as “mixed” mailpieces.

Once they have been tipped out to one side, mixed mailpieces are still in sequence but they are on another edge, having gone from landscape orientation to portrait orientation and vice versa.

Thus, the operative no longer has to lift trays loaded with mailpieces so as to place them on the unstacker magazine and no longer needs to orient the mailpieces on edge and in sequence on the unstacker magazine.

### BRIEF DESCRIPTION OF THE DRAWINGS

The present invention can be better understood and other advantages appear on reading the following detailed description of an embodiment given by way of non-limiting example and with reference to the accompanying drawings, in which:

FIG. 1 is a diagrammatic perspective view of the apparatus of the invention for feeding an unstacker magazine from a feed conveyor;

FIGS. 2a and 2b diagrammatically show the apparatus of the invention while a tray is being tipped; and

FIG. 3 diagrammatically shows the apparatus of the invention in a retracted mode.

### DESCRIPTION OF THE EMBODIMENT

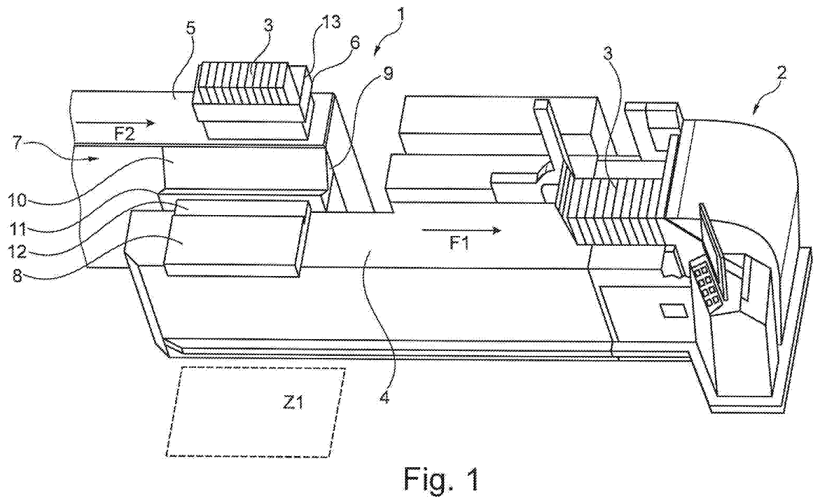

The apparatus 1 of the invention as shown in FIG. 1 is particularly adapted for feeding an unstacker magazine 2 with mailpieces 3 in a postal sorting or logistics center.

The term “unstacker magazine” 2 is used to mean a magazine for temporarily storing mailpieces that feeds an unstacker.

The mailpieces 3 that feed the unstacking magazine are generally letters, parcels, packets, etc.

The apparatus 1 of the invention as shown in FIG. 1 comprises a conveyor bed 4 designed to convey mailpieces 3 on edge to the unstacker magazine 2 in a first conveying direction F1 and a feed conveyor 5 designed to convey trays 6 loaded with mailpieces 3 in a second conveying direction F2 to the conveyor bed 4.

The apparatus further comprises tray tipper means 7 disposed between the downstream end of the feed conveyor 5 and the upstream end of the conveyor bed 4.

In this example, the tray tipper means 7 comprise a tray-receiving plate 8 that overlies the conveyor bed 4, and an L-shaped cradle 9 interposed between the feed conveyor 5 and the conveyor bed 4, which L-shaped cradle is designed to tip a tray 6 loaded with mailpieces 3 over onto one side transversely to the conveying direction F2 onto the tray-receiving plate 8.

The L-shaped cradle 9 comprises a first ramp 10 that extends downwards from the feed conveyor 5 to below the tray-receiving plate 8 and a second ramp 11 that extends back up towards the tray-receiving plate 8.

The first ramp 10 enables an operative positioned in the zone Z1 to cause a tray 6 to be tipped and slid transversely relative to the first and second conveying directions F1 while the second ramp 11 blocks the foot of the tray 6 at the bottom of the first ramp 10.

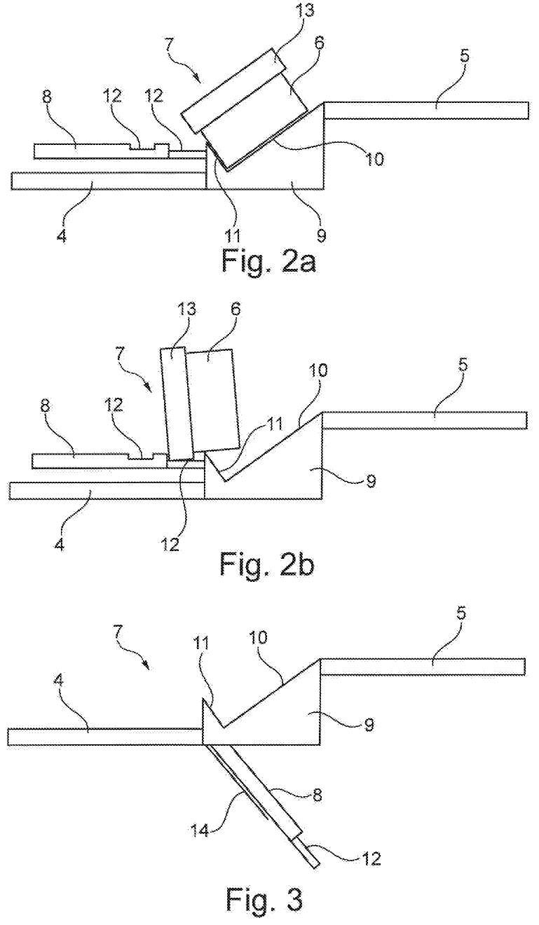

The L-shaped cradle 9 thus makes it possible to receive a tray 6 in such a manner that it is inclined between the two ramps 10, 11, as shown in FIG. 2a.

The second ramp 11 also makes it possible to create a tipping point for the inclined tray 6, so that an operative in zone Z1 then merely has to pull the tray 6 towards said operative via the side facing said operative in order to tip the tray 6 over onto the tray-receiving plate 8, as shown in FIG. 2b, and in order to retrieve the mailpieces 3 on edge so as to cause them to slide to the unstacker magazine 2 by means of one or more retaining paddles mounted to move along the conveyor bed 4.

The tray-receiving plate 8 is also provided with a tray-receiving indent 12 that can be seen in FIGS. 2a, 2b, and 3, and that is designed to correspond to the profile of the tray 6 that is being tipped over.

In this example, the indent 12 corresponds to the top rim 13 of each of the trays that also serves as a handle for handling the tray 6.

It can be understood that a plurality of tray-receiving indents 12 corresponding to various different types or sizes of tray may be provided in the tray-receiving plate as can be seen in FIGS. 2a and 2b.

The tray-receiving plate 8 is also mounted to be retractable under the L-shaped cradle 9, e.g. by means of a slideway 14, so that, when the tray-receiving plate is retracted, as shown in FIG. 3, the conveyor bed can be used with another feed conveyor arranged for unloading mailpieces 3 via the front at the upstream end of the bed 4.

Naturally, the present invention is in no way limited to the above-described embodiment, which can undergo modifications without going beyond the ambit of the invention.

1. An apparatus for feeding an unstacker magazine with mailpieces on edge, said apparatus comprising:
a conveyor bed configured to convey the mailpieces on edge to the unstacker magazine in a first conveying direction,
a feed conveyor configured to convey trays loaded with mailpieces to the conveyor bed in a second conveying direction, and
tray tipper means interposed between said feed conveyor and said conveyor bed, which means are configured to tip a tray over onto one side from the feed conveyor onto the conveyor bed in such a manner as to bring the mailpieces on edge from the tray to the unstacker magazine, wherein said tray tipper means form an L-shaped cradle configured to receive a tray in such a manner that it is inclined transversely to said first and second conveying directions between the feed conveyor and the conveyor bed, and in that said tray tipper means further comprise a tray-receiving plate that overlies the conveyor bed in front of the L-shaped cradle and in which a tray-receiving indent is formed, said indent being arranged to block a tray when it is tipped from the L-shaped cradle onto the plate in order to enable the mailpieces to be unloaded on edge onto the tray-receiving plate.
